(19) United States
(12) Patent Application Publication
(10) Pub. No.: US 2015/0257023 A1
(43) Pub. Date: Sep. 10, 2015

(54) DISTRIBUTION OF NETWORK STATUS AND INFORMATION IN WLAN NETWORKS FOR SELF-OPTIMIZATION/ORGANIZATION

(71) Applicant: SONY CORPORATION, Tokyo (JP)

(72) Inventor: Kåre Agardh, Lund (SE)

(21) Appl. No.: 14/374,097

(22) PCT Filed: Nov. 1, 2013
(86) PCT No.: PCT/IB2013/002431

§ 371 Date: Jul. 23, 2014

(51) Int. Cl. H04W 24/08

(52) U.S. Cl. CPC H04W 24/08; H04W 84/042

(57) ABSTRACT

The invention is directed to systems, methods and computer program products for distributing information associated with a network. An exemplary method comprises: defining at least one information, wherein the at least one information is associated with at least one security level; selecting a listening device within a listening range of the network, wherein the listening device is selected based on the at least one security level; and transmitting the at least one information to the listening device.

### BACKGROUND ART

Wireless networks are usually formed using a central access point and a number of connected devices around the access point. Each device uses a specific frequency (channel), and since the number of channels is limited, there can be multiple devices using the same channel(s), thereby causing conflicts and collisions. These conflicts are handled by retransmission of information so that the network provides an error free transport mechanism to protocols and applications associated with the access point or connected devices.

Retransmissions cause degradation of total throughput/capacity of the network and therefore there is a need to minimize retransmissions. This minimization can be achieved by careful planning of channel usage and other radio parameters in the access point associated with a location. This is referred to as cell planning. Currently, for wireless area local access (WLAN) networks, cell planning is accomplished in a static manner and based on occasional site measurements/mapping efforts.

Due to the exponential increase in traffic from and to mobile devices, there is tremendous mobile industry interest in methods to optimally steer information over WLANs or cellular networks, so that the networks are able to handle all information in an efficient manner There is a need to optimize capacity in networks and there is also a need to make sure an optimal network is being used for a particular application (e.g., an application associated with a mobile device).

Today, WLANs are overly static. The reason is that devices stay connected to an access point in an inflexible manner. An access points is unable to obtain a picture of the whole environment in order to take a decision on how to optimize network capacity and how to self-organize channel usage or other radio parameters. Currently, there are few means to share information about the network environment, e.g., channels in usage, devices in range, radio parameters, retransmissions etc.

Such limitations in existing networks prevent efficient use of available bandwidth, and means to find solutions for more self-adapting and self-forming networks are critical for future network technologies. This invention proposes a method of sharing network information to allow distributed decisions on how networks are organized.

### SUMMARY

Embodiments of the invention are directed to systems, methods and computer program products for distributing information associated with a network. An exemplary method comprises: defining, using a computing device processor, at least one information, wherein the at least one information is associated with at least one security level; selecting, using a computing device processor, a listening device within a listening range of the network, wherein the listening device is selected based on the at least one security level; and transmitting, using a computing device processor, the at least one information to the listening device.

In some embodiments, the network comprises a wireless local area network (WLAN).

In some embodiments, the WLAN comprises a cellular network.

In some embodiments, the at least one information comprises statistical information for debugging or optimizing the network or a channel associated with the network.

In some embodiments, the at least one information is transmitted over a first channel.

In some embodiments, the first channel is a dedicated channel such that no other information is transmitted or received when the at least one information is transmitted over the first channel

In some embodiments, the listening device comprises a specific listening device.

In some embodiments, the at least one information comprises at least one of an error rate, a timing or delay, a multiple-input and multiple-out (MIMO) rank, a list of visible networks or devices, parameters associated with networks or devices connected to or unconnected to the network, local output power, or a modulation scheme.

In some embodiments, the at least one information comprises descriptive information and spectrum information associated with an access point associated with the network.

In some embodiments, the at least one information comprises a radio parameter associated with the network and information associated with an access point associated with the network.

In some embodiments, the network is constructed based on a time-multiplexing principle.

In some embodiments, the listening device comprises at least one of a portable communication device, a laptop, a watch, a music player, a television, or a motor vehicle.

In some embodiments, the network is identified by a service set identification (SSID) or radio channel.

In some embodiments, the at least one information is uploaded to a remote cloud server.

In some embodiments, the method further comprises enabling avoidance of collision between two information sets on a channel associated with the network.

In some embodiments, the at least one security level ranges from a zero security level to a predetermined number of security levels.

In some embodiments, the listening device is further selected based on an amount associated with the at least one information.

In some embodiments, an apparatus is provided for distributing information associated with a network. The apparatus comprises: a memory; a processor; and a module stored in the memory, executable by the processor, and configured to: define at least one information, wherein the at least one information is associated with at least one security level; select a listening device within a listening range of the network, wherein the listening device is selected based on the at least one security level; and transmit the at least one information to the listening device.

In some embodiments, a computer program product is provided for distributing information associated with a network. The computer program product comprises a non-transitory computer-readable medium comprising a set of codes for causing a computer to: define at least one information, wherein the at least one information is associated with at least one security level; select a listening device within a listening range of the network, wherein the listening device is selected based on the at least one security level; and transmit the at least one information to the listening device.

### BRIEF DESCRIPTION OF DRAWINGS

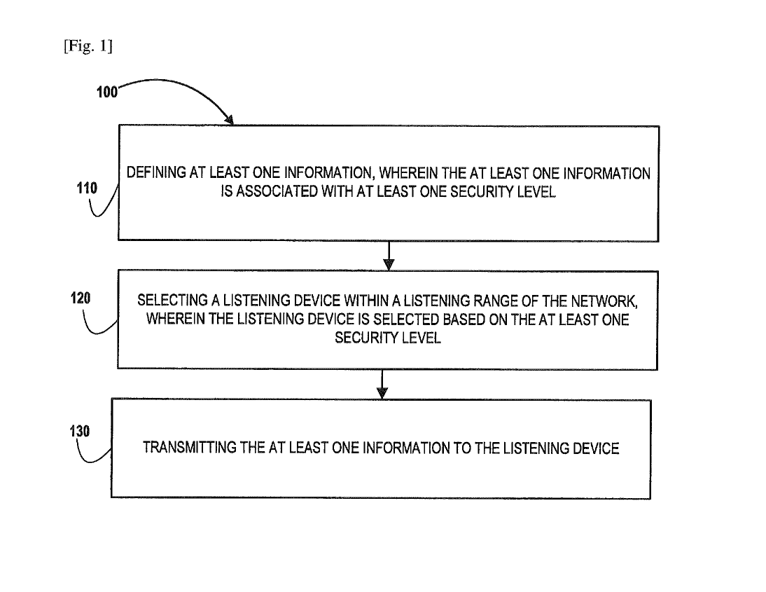

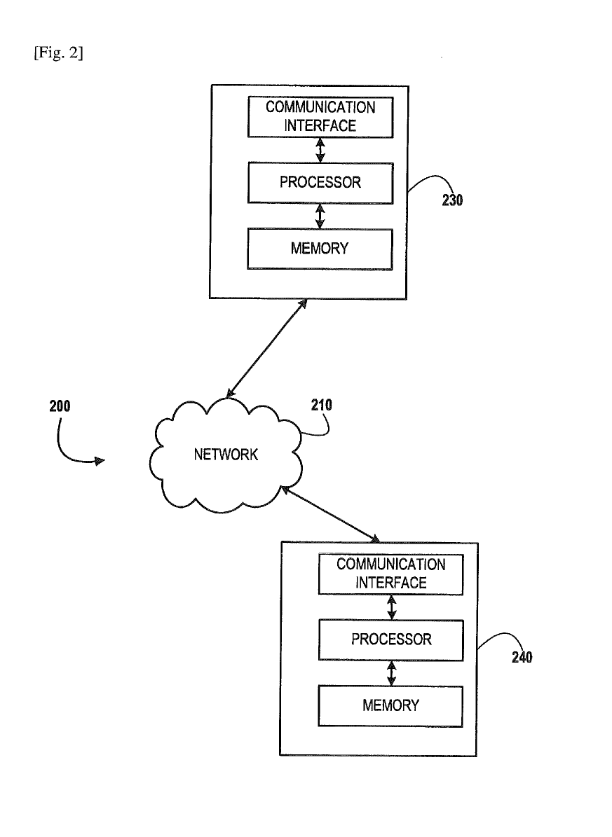

Having thus described embodiments of the invention in general terms, reference will now be made to the accompanying drawings, where:

[FIG. 1] FIG. 1 is an exemplary process flow for distributing network information associated with a network, in accordance with embodiments of the present invention;

[FIG. 2] FIG. 2 is an exemplary network environment, in accordance with embodiments of the present invention.

### DESCRIPTION OF EMBODIMENTS

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for sharing network radio environment statistics for debugging and network optimization. As used herein, a network may refer to a WLAN or cellular network.

In some embodiments, a method is provided for wireless devices to broadcast information about the network radio environment, which can be used by other devices (e.g., other wireless devices) to adjust and optimize the network (or connections to the network). Generally, the broadcasted information includes information about the network, connected devices, unconnected devices that are listening for information, etc. Specifically, the broadcasted information includes error rates, timings and delays, multiple-input and multiple-output (MIMO) ranks, visible networks/devices and related details and parameters for each network/device, local output power, modulation schemes, etc. As used herein, a wireless device may include at least one of a portable communication device, a laptop, a watch, a music player, a television, a motor vehicle, or the like.

The invention enables formation of a dedicated network, wherein the dedicated network is identified by an identifier. The identifier may be a dedicated service set identification (SSID), radio channel, or the like. Information is distributed on this dedicated network to any listening device. In some embodiments, the dedicated network is a dedicated virtual network. The dedicated virtual network is constructed based on a time-multiplexing principle.

Additionally, the invention enables distribution of information to devices on the network (or devices that are not yet connected to the network but are initiating connections to the network) by uploading the information to a remote cloud server. This would enable network optimization and decision-making based on the distributed information (e.g., previously described broadcasted information, information about the network, devices on the network, other networks, etc.). In some embodiments, a method of collision avoidance is also provided. The method is associated with collision avoidance protocol for broadcasting information on a dedicated channel associated with the network.

In some embodiments, network functionality is supported by multiple access points. To an end user accessing the network, the multiple access points appear as multiple service set identifiers (SSIDs). The invention enables activation of the access points over Wi-Fi Direct.

In some embodiments, the invention limits an amount of information transmitted over a channel. This reduces the transmission time (or air time) over the network, reduces the power consumed in producing the information transmission, and also reduces the number of collisions on the network.

Additionally, the invention defines levels or quantums of information. Each level is associated with a security requirement (e.g., an authentication and encryption requirement). The authentication and encryption of information substantially prevents exploitation of the information. For example, basic information that is made available to devices in range of an access point may have no security requirement (e.g., no authentication and/or encryption) or a minimal security requirement. As a further example, sensitive or extended information (e.g., information comprising detailed debugging and statistical information) that is being transmitted to a specific device from the access point via the network may have a higher security requirement (e.g., a predetermined higher authentication and encryption level).

An exemplary basic information set is now described. The basic information set comprises an access point list, including descriptive information and spectrum information associated with each access point. In some embodiments, the basic information set is at least less than or equal to 400 bytes. At a throughput of 200 Mbit/second which can be achieved on a standard WLAN, this basic information set has an active air time of approximately 200 us.

An exemplary extended information set is now described. The exemplary information set comprises descriptive information associated with each device on the network, radio parameters associated with the network, and details associated with one or more access points on the network. In some embodiments, the extended information set is less than or equal to 1 kB. At a throughput of 200 Mbit/second which can be achieved on a standard WLAN, this basic information set has an active air time of approximately 500 us.

Referring now to FIG. 1, FIG. 1 describes an exemplary process flow for distributing network information associated with a network. At step 110, the process flow comprises defining, using a computing device processor, at least one information, wherein the at least one information is associated with at least one security level. At step 120, the process flow comprises selecting, using a computing device processor, a listening device within a listening range of the network, wherein the listening device is selected based on the at least one security level. At step 130, the process flow comprises transmitting, using a computing device processor, the at least one information to the listening device. As used herein, the terms “data” and “information” are interchangeable.

Referring now to FIG. 2, FIG. 2 presents an exemplary block diagram of the network environment 200 for implementing the process flows described herein, in accordance with embodiments of the present invention. As illustrated, the system environment 200 includes a network 210, an access point 230, and a listening device240. As shown in FIG. 2, the access point 230 and the listening device 240 are each operatively and selectively connected (e.g., via one or more wireless mechanisms) to the network 210, which may include one or more separate networks. The access point 230 is a computing device (e.g., a server) comprising a processor, a memory, and a module stored in the memory, executable by the processor, and configured to perform the various processes described herein. The listening device 240 is a computing device (e.g., a mobile computing device) comprising a processor, a memory, and a module stored in the memory, executable by the processor, and configured to perform the various processes described herein. For example, the listening device 240 comprises at least one of a mobile computing device, a mobile phone, an audio device, a television, a tablet, or a watch. The access point 230 and the listening device 240 may be able to establish connections to the network 210 via one or more wired or wireless mechanisms.

Each processor described herein generally includes circuitry for implementing audio, visual, and/or logic functions. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory.

Each memory may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

The various features described with respect to any embodiments described herein are applicable to any of the other embodiments described herein. Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electro-magnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable information processing apparatus in order to produce a particular machine, such that the one or more computer-executable program code portions, which execute via the processor of the computer and/or other programmable information processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable information processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable information processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. A method for distributing information associated with a network, the method comprising:
defining, using a computing device processor, at least one information, wherein the at least one information is associated with at least one security level;
selecting, using a computing device processor, a listening device within a listening range of the network, wherein the listening device is selected based on the at least one security level; and
transmitting, using a computing device processor, the at least one information to the listening device.

2. The method of claim 1, wherein the network comprises a wireless local area network (WLAN).

3. The method of claim 2, wherein the WLAN comprises a cellular network.

4. The method of claim 1, wherein the at least one information comprises statistical information for debugging or optimizing the network or a channel associated with the network.

5. The method of claim 1, wherein the at least one information is transmitted over a first channel.

6. The method of claim 5, wherein the first channel is a dedicated channel such that no other information is transmitted or received when the at least one information is transmitted over the first channel.

7. The method of claim 1, wherein the listening device comprises a specific listening device.

8. The method of claim 1, wherein the at least one information comprises at least one of an error rate, a timing or delay, a multiple-input and multiple-out (MIMO) rank, a list of visible networks or devices, parameters associated with networks or devices connected to or unconnected to the network, local output power, or a modulation scheme.

9. The method of claim 1, wherein the at least one information comprises descriptive information and spectrum information associated with an access point associated with the network.

10. The method of claim 1, wherein the at least one information comprises a radio parameter associated with the network and information associated with an access point associated with the network.

11. The method of claim 1, wherein the network is constructed based on a time-multiplexing principle.

12. The method of claim 1, wherein the listening device comprises at least one of a portable communication device, a laptop, a watch, a music player, a television, or a motor vehicle.

13. The method of claim 1, wherein the network is identified by a service set identification (SSID) or radio channel.

14. The method of claim 1, wherein the at least one information is uploaded to a remote cloud server.

15. The method of claim 1, further comprising: enabling avoidance of collision between two information sets on a channel associated with the network.

16. The method of claim 1, wherein the at least one security level ranges from a zero security level to a predetermined number of security levels.

17. The method of claim 1, wherein the listening device is further selected based on an amount associated with the at least one information.

18. An apparatus for distributing information associated with a network, the apparatus comprising:
a memory;
a processor; and
a module stored in the memory, executable by the processor, and configured to:
define at least one information, wherein the at least one information is associated with at least one security level;
select a listening device within a listening range of the network, wherein the listening device is selected based on the at least one security level; and
transmit the at least one information to the listening device.

19. A computer program product for distributing information associated with a network, the computer program product comprising:
a non-transitory computer-readable medium comprising a set of codes for causing a computer to:
define at least one information, wherein the at least one information is associated with at least one security level;
select a listening device within a listening range of the network, wherein the listening device is selected based on the at least one security level; and
transmit the at least one information to the listening device.
